(19) United States
(12) Patent Application Publication
(10) Pub. No.: US 2005/0256932 A1
(43) Pub. Date: Nov. 17, 2005

(54) System for messaging using shared messaging devices

(75) Inventor: Mark Catellana, Dallas, TX (US)

Correspondence Address: MARGER JOHNSON & MCCOLLOM, P.C., 210 SW MORRISON STREET, SUITE 400, PORTLAND, OR, 97204, US

(73) Assignee: Accdeo, Inc., Dallas, TX (US)

(21) Appl. No.: 11/129,182

(22) Filed: May 13, 2005

Related U.S. Application Data
(60) Provisional application No. 60/571,048, filed on May 14, 2004.

(51) Int. Cl. G06F 15/16

(52) U.S. Cl. 709/206; 356/328

(57) ABSTRACT

Described are a shared messaging device and method of messaging using shared messaging devices. An electronic messaging device has a display for communicating multiple messages to consumers using a single messaging device. Using the electronic messaging device, advertisers and others are able to display messages to consumers, while sharing the messaging cost among the providers of the multiple messages.

### TECHNICAL FIELD

This patent application claims priority from U.S. Provisional Patent Application Ser. No. 60/571,048, filed May 14, 2004, which is hereby incorporated by reference for all purposes. This disclosure relates to messaging, and, more specifically, to a system for advertising using shared messaging devices.

### BACKGROUND

Advertising is a fiercely competitive business in which retailers vie for the attention of the consumer with the hope of enticing the consumer to purchase products or services provided by the retailer. In pursuit of this goal, advertisers are continually seeking new avenues for approaching the consumer and further maximizing the opportunities that already exist. Within this competition, resources such as space, manpower, and computing power are often limiting factors. As a result, advertisers are interested in maximizing their exposure to consumers while simultaneously minimizing their cost and effort. One such known approach is to attempt to market products to captive audiences, such as consumers undertaking daily activities, such as buying groceries or purchasing gasoline.

Retailers, such as convenience stores with gasoline pumps, frequently employ light emitting diode (LED) signs in an effort to market or advertise products to consumers. Such messaging devices have historically been used for state lottery programs, where the messaging device conveys the jackpot amount. These messaging devices have also been used, on occasion, to convey public service information, such as Amber Alert bulletins. The messaging devices are generally stand-alone devices and are operated through an agreement between the retailer or host and the state lottery. Lottery sales often act as loss leaders, with retailers counting on lottery purchasers to purchase additional items while in the store to buy their tickets. As a rule, with the exception of Amber Alert bulletins, these lottery messaging devices are not used for another purpose. Retailers might also use their own separate LED displays to advertise products they are offering for sale.

The result of single users using stand-alone devices is that floor space, or alternatively wall space, becomes a premium. Each advertiser wishing to use such a sign has to have his or her own sign. Additionally, such users must pay to service and maintain these signs, as well as pay for their operation. Users must also make decisions on messaging, and whether their messages will have one-way or two-way functionality, and must also deal with problems associated with updating the messages. For small advertisers, stand-alone devices require a lot of know-how, expense, and manpower to operate.

This historical approach also has considerable configuration problems. Although the LED displays can be bought relatively cheaply, they are difficult to configure because a user must manually type each message to each sign using a remote control device. When the user wants to change the message, he must again manually type in the new message. Alternatively, the user can purchase a program to allow him to configure the message through his own personal computer and then transfer the complete message to the sign, but again, this approach adds cost and maintenance and works only with a single display. As a result, these steps would have to be repeated for each display.

In the state lottery model, and others attempting to link public signs, several mechanisms have been attempted to reach a workable solution. For example, linking has been attempted through paging networks using 900 MHz band radio frequency. However, this approach has significant drawbacks. It requires short message text, well below that of the capacity of the LED signs, is limited in range, preventing the messages from reaching all markets at one time, and raises security concerns as the signal can be surreptitiously received by others. Additionally, it requires the use of pagers and a third party paging network, which again add to the complexity and cost, and generally do not offer confirmation of the arrival of the message.

Other attempts to publicly link messaging devices have involved using hidden signals on an FM radio band. Again, this solution limits the amount of text that can be displayed, requires the use of additional equipment, such as antennas, requires a location station or subscriber, and can cause space issues, limiting the areas where such signs can be placed.

Another approach has involved sole users employing installed, dedicated systems to provide messaging and information through their networks. These systems can deliver a dedicated message to a given location but are expensive to implement and are therefore typically dedicated to the sole user. As a result, sole users typically have proprietary or protected market share for their systems and generally cannot share, lease or sell space to other users. As such, they are not neutral carrier/providers. Sole users with proprietary or secure data are generally unable to become neutral carriers.

A major drawback of user-dedicated systems is that image devices, networks, bandwidth and connectivity are expensive and take space. An advertiser attempting to have a series of such systems at remote locations would quickly run out of money. Facilities attempting to benefit from multiple user-dedicated systems would quickly run out of space.

An additional drawback of conventional messaging is that the messages are required to be of the lowest common denominator. With one-way messaging, which is generally less expensive than two-way messaging, the message stream goes from the home base to the receiver, generally located some distance away. The home base has no way of knowing whether the proper message has arrived, or whether the message has arrived at all. Although two-way messaging can solve this problem, it adds considerable expense and complexity, which make the advertising opportunity less appealing to advertisers. Even installations with technologically advanced systems are therefore limited by the technology level of other users receiving the same messages. As a result, the messages are simple and generally short.

As a result of these limitations, current systems cannot operate even at the level of the available art. There is a great lag time in the breadth and scope of available infrastructure and capability. Users are losing the benefit of structural capacity and particularized options.

Embodiments of the invention address these and other deficiencies in electronic point-of-sale advertising systems.

### BRIEF DESCRIPTION OF THE DRAWINGS

The description may be best understood by reading the disclosure with reference to the accompanying drawings.

FIG. 1 is a block diagram showing an electronic messaging device used for embodiments of the invention.

FIG. 2 is a block diagram showing components of a shared advertising network according to embodiments of the invention.

FIG. 3 is an example retail floor plan illustrating the location of messaging displays according to embodiments of the invention.

FIG. 4 is a diagram illustrating various participants in a shared advertising network according to embodiments of the invention.

FIGS. 5A and 5B are examples of a shared message generated by embodiments of the invention.

FIG. 6 is a flow diagram showing processes that can be performed by the network of FIG. 2, including the creation of a shared message.

### DETAILED DESCRIPTION

Embodiments of the invention include an electronic messaging system that displays messages to consumers using shared messaging devices. The system is capable of operating on a preexisting data communications backbone, or alternatively on a new system designed specifically for the purpose. A pipeline brings data into a given store or installation. This pipeline can be through phone or cable lines, such as DSL or T1, satellite hookups, or other communication paths. Receivers/transceivers or controllers receive, store and distribute the received data. One or more Electronic Messaging Devices (“EMDs”) display the data, which may include text messages, images, sounds or other communication methods.

Using the example of the convenience store, a given store may include a single data hub that sends signals to different EMD's throughout the store location. The data hub can be located within the store, but need not. Electronic messages can be sent simultaneously to each of the EMD's based on a pre-loaded script that can be displayed at a predetermined time, or entered for display immediately or in real time. Each EMD can receive messages on separate message tracks, the content of which is owned, leased or managed by different advertisers and facilitated through a neutral provider or network administrator.

Although the present invention is discussed in the context of a small retail outlet, more specifically a convenience store selling gasoline, any retail outlet with electronic point-of-sale displays, or the potential for such displays, is contemplated and within the scope of the invention.

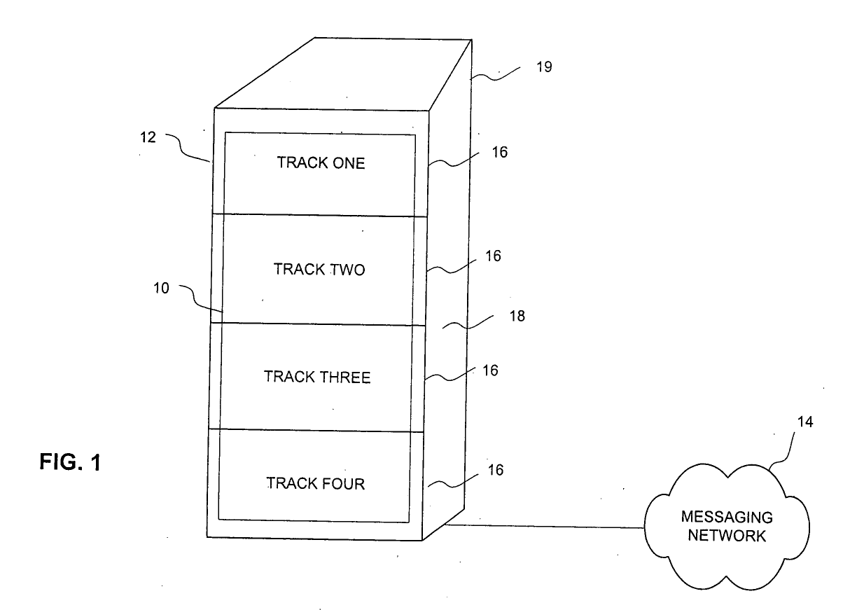

Turning to FIG. 1, an electronic messaging device (“EMD”) 12 according to an embodiment of the invention is shown. The EMD 12 includes a display 10 capable of displaying messages delivered through a shared messaging network 14. The EMD further includes a housing 19 to contain the EMD electronics 18. Each EMD 12 can be a stand-alone device, or it can be combined with some other functionality in a retail setting, such as housed within a lottery ticket dispenser, mounted flush in a counter, or mounted to some other fixture to permit the display 10 to be seen by consumers, for example. The display 10 can be a light emitting diode (LED), liquid crystal display (LCD), cathode ray tube (CRT), plasma screen, touch screen, front or rear projector, or any other type of display capable of being configured to display a message. One such example is an Alpha® 215 series. The display 10 contains one or more message tracks 16, each message track being configurable to display a different message. Because they are separable, each message track 16 can display messages from different users or message providers. Alternatively, a single message can be displayed across multiple message tracks. The message tracks 16 may be adjacent or physically separable. The EMD electronics 18, receive signals from a controller, described below, manage the central operations of the EMD 12, and permit the EMD to communicate with a configurable user interface 26 and other EMDs. The EMD 12 can also optionally contain speakers (not shown) for allowing the EMD to emit sound.

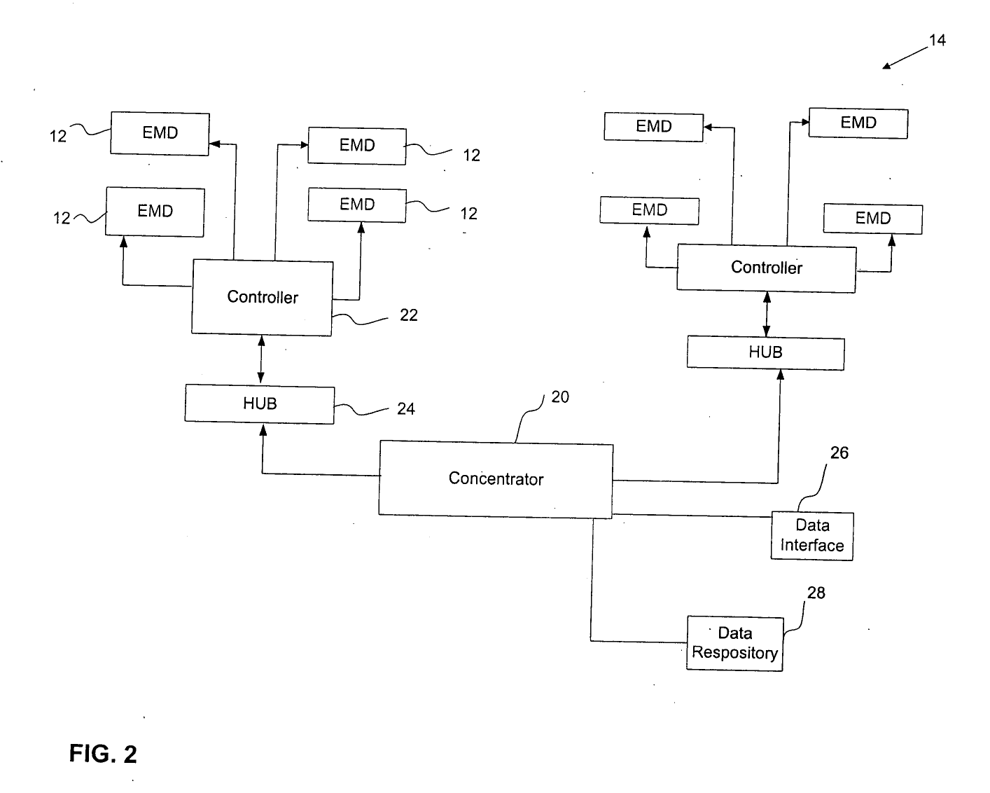

An example shared messaging network 14 is illustrated in FIG. 2. In the illustrated messaging network 14 a number of EMDs 12 are organized in groups and communicate with a common hub 24, which can be need not be for example a Linksys® WAP55AG. Individual hubs 24 can be coupled to almost any number of EMDs 12. Additionally, although two hubs 24 are shown, any number of hubs is possible in the messaging network 14. It is not necessary that EMDs 12 sharing a hub 24 even be located in the same physical location. Likewise, the EMDs 12 associated with a particular hub 24 can be of different types, for example stand-alone, counter mounted, floor mounted, or projected overhead. Those skilled in the art will appreciate that embodiments of the invention can operate on any acceptable network, even if it differs from the one illustrated in FIG. 2.

Each hub 24 is controlled by a controller 22, which can be coupled to each EMD 12 by a communication cable (not shown) or wireless network. Where a wireless network is employed, a bridge adapter is used to permit communication between the EMD 12 and controller 22. One such example is a WET 11. Additionally, an Ethernet II adapter can be used to permit communication between the controller 22 and EMD 12. The controller 22 facilitates data communication between the EMDs 12 in its associated hub and the other components on the messaging network. In some embodiments, the controller 22 need not be present, and the EMDs 12 communicate directly with the other portions of the messaging network 14. The data containing the messages to be displayed on the EMDs 12 may be generated or changed responsive to commands issued over the network 14 to the controller 22. The messages, including sounds and images, generated by the controller 22 may be identical for each of the EMDs 12 connected to the controller or elsewhere on the network 14, or the messages for each EMD can be different. The controller 22 can likewise control scrolling, graphics and flashing, and the rate at which messages are displayed on the display 10 on the EMDs. Configuration data for the messaging network 14 can be created at a data interface 26 and stored in one or more network data repositories 28 associated with the concentrator 20. In other embodiments, the data interface 26 may store the data directly.

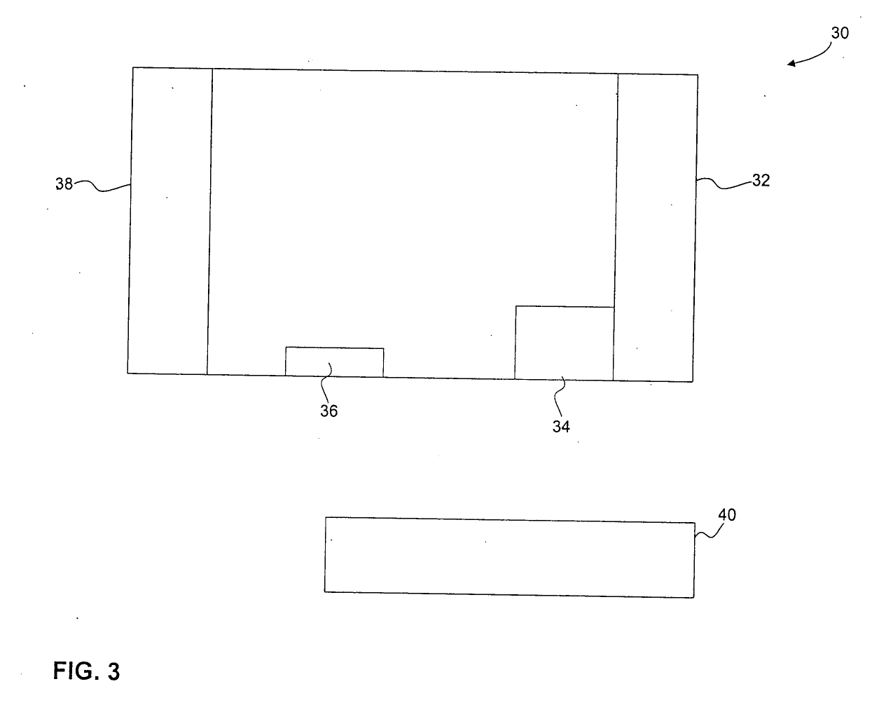

Details of how the system in FIG. 2 generates, transmits and displays messages are described with reference to FIGS. 3 through 6. For brevity, functions relating to messaging will be referred to as occurring in the concentrator 20, although they could be performed in other parts of the network 14.

FIG. 3 illustrates an example store layout where various physical components of the network 14 can be situated. The network 14 can be contained within a single store or can be distributed throughout several installations. The store 30 of FIG. 3 includes a storage/office area 32, which can act as an entry point for messaging data to be transmitted to the various EMDs 12. Messaging data can enter the store by phone or cable lines, such as DSL or T1, or through satellite hookups, or can originate within the given store 30. The store 30 also includes a sales counter area 34, where retail transactions take place. The counter area 34 is generally the primary location for point-of-sale displays 34 because it is where sales generally occur. As a result, an EMD 12 is likely located on or near the counter area 34. EMDs at this location are likely located within the customer's line-of-site on the counter, above the counter, or contained within the counter. Messages delivered by these EMDs 12 are likely short, targeted messages directed to customers paying for purchases or waiting in line to pay for purchases. The EMD 12 in the counter area 34 is also the likely location of an In Counter Merchandiser (ICM). Operators of a state lottery, for those states having lotteries, are motivated to pay for the ICM, because it is primarily a retail device for instant win lottery tickets. Therefore, one message or message string found at this location would likely be a lottery message or update. Additional messages displayed on this EMD 12 would also likely include high margin items such as cigarettes.

The store 30 also has a window 36, which can serve as a location for a second EMD 12. This EMD 12 is visible to customers entering the store 30. Additional EMDs 12 can be located by a cooler 38 or some other merchandising area of the store. In the illustration of FIG. 3, the store 30 also includes a gas pump island 40, which can serve as an additional location for an EMD 12.

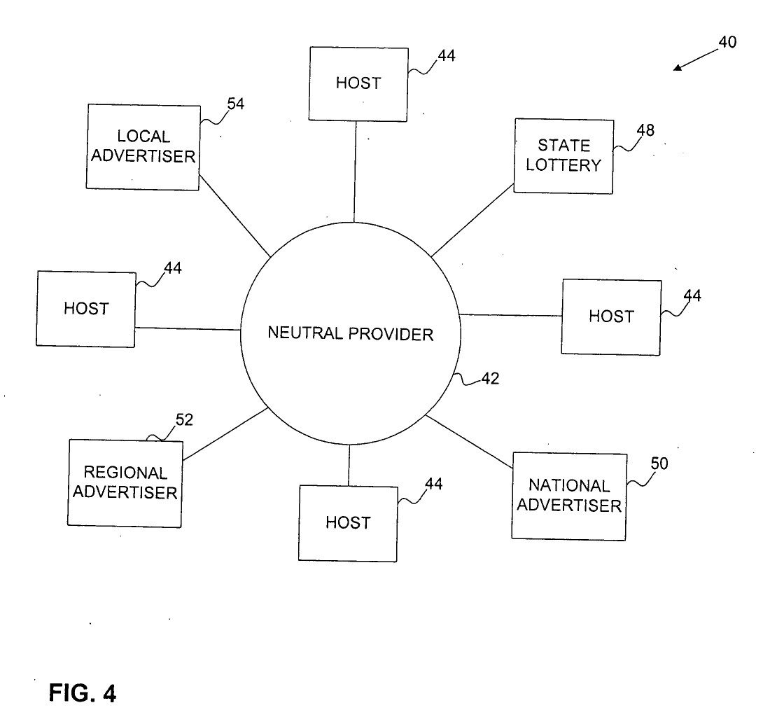

FIG. 4 illustrates in block form the various strategic partners to a messaging community 40. At the core of the messaging community 40 is a neutral provider/network administrator 42. The neutral provider 42 contracts with various strategic partners to create the shared messaging community 40. The members of the messaging community 40 can include the host 44 or store owner. The host 44 provides the physical location of the EMDs 12 and provides access to the consumer. The host 44 can be a small independent host, like a “mom and pop” store, a regional retailer, or a national retailer. As such, the host 44 might operate in one or more cities, in one or more markets, or in one or more time zones.

Another member of the shared messaging community 40 can be a participating state or multi-state lottery 48. State lotteries 48 would likely be interested in providing an EMD 12, as the state lottery has been the historical user of other types of signs. However, it is contemplated that any member of the messaging community, including a neutral provider, can provide the EMD 12. Other members of the messaging community can include a national advertiser 50, a regional advertiser 52, and/or a local advertiser 54. The advertising members 50, 52, 54 can provide capital to support the messaging community 40. Of course, it is not necessary that a messaging community have these particular members 50, 52, 54, as membership may vary according to the needs and wants of the host 44 and the members of the messaging community 40.

Although the present example of a messaging community 40 is described as having particular member types with particular arrangements between members, any community of two or more members sharing messages is contemplated and within the scope of the invention.

The neutral provider 42 operates the messaging community 40 and prevents competing retailers from having to rely on their competitors for message track placement on the EMDs 12. The neutral provider 42 can provide contracting with the host 44 to provide placement for the EMDs 12. In so doing, the neutral provider 42 frees the host 44 from itself having to contract with members of the messaging community 40, or provide the technical support to operate the community. To compensate for hosting one or more EMDs 12, the host 44 can, but need not, be provided with message track space or time.

The neutral provider 42 can likewise contract with advertisers, which can, include the local advertiser 54, the regional advertiser 52, and the national advertiser 50. The neutral provider 42 typically obtains and approves messages, coordinates message plays, and ensures that each member of the messaging community 40 is meeting its obligations, such as payment, message delivery, message content, and message placement.

The advertisers 50, 52, 54 provide payment for message plays on the EMDs 12. The amount of the payment can be determined by contract between the parties and may include such factors as the number of EMDs 12 at which messages will be displayed, the frequency with which messages will be displayed, the time of day or day of week the messages will be displayed, the length of the message which can be displayed, and the number of message tracks 16 involved in displaying the message. These payments can be used to compensate the neutral provider for coordinating the messaging community 40, pay the system and connectivity costs associated with operating the messaging community 40, and purchase EMDs 12 for use in the messaging community.

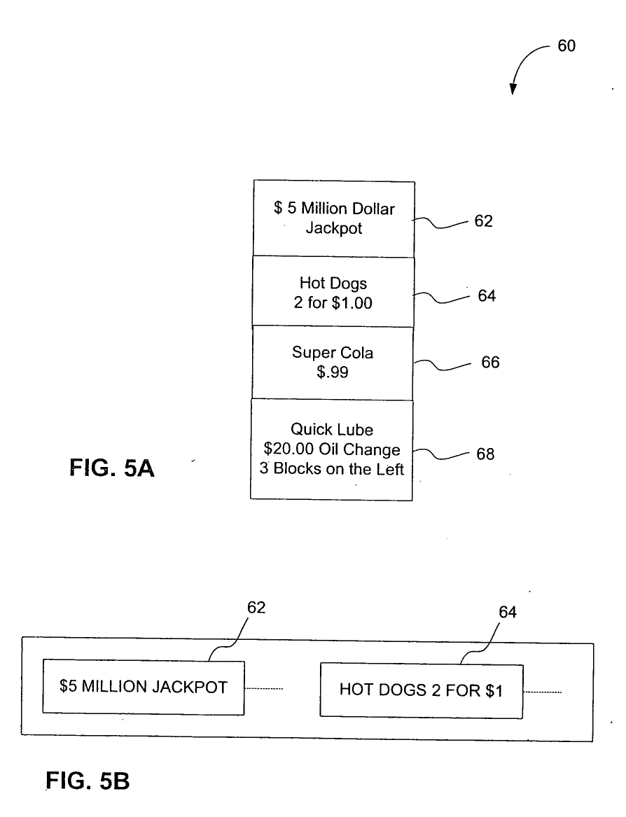

FIGS. 5A and 5B are examples of a shared message 60 that can be generated by embodiments of the invention. In FIG. 5A the shared message 60 is displayed in a vertical fashion and appears together on the display 10. In FIG. 5B, the shared message is played horizontally in ticker fashion. In the example of FIG. 5A, messages are shared by the state lottery 62, the store or host 64, the local retailer 66, and the brand advertiser 68. Additional types of messages could include public service announcements, which do not belong to any one member of the message community 40. Examples of the types of messages each might purchase or lease are provided in Table 1 below.

TABLE 1

| Message Origin | Message Content |
|---|---|
| State Lottery | Jackpots, Next Drawing, Unclaimed Wins |
| Host | Specials, Hours, Job Openings, Time until Closing |
| National Brand | Specials, Cross-promotions, Product Features |
| Local Business | Address, Hours of Operation, Promotions, Reviews |
| Public Service | Amber Alerts, power outages, public transportation |
| | disruptions, smog warnings |

An example EMD 12 could be shared by the state lottery, the host convenience store, a national brand, a local business, such as an auto repair service, and a public service provider, such as the local transportation system. Each member of the messaging community 40 can be allocated a “portion” of the EMD 12, with each portion representing a message track 16. The message tracks 16 in FIG. 1 can be displayed simultaneously, or each can be displayed sequentially. In another embodiment, a touch-screen display can provide a menu of available messages, giving a consumer the opportunity to select which message track is played.

The lottery message might indicate that the next drawing is on April 1, and the jackpot amount is $5,000,000. The host, or convenience store, might wish to advise customers that there is special on hot dogs, 2 for $1.00. This special could be associated with a national brand special, thus serving as a cross promotion between the host and national brand. Similarly, two national brands might run a cross promotion. For example ABC Coca and Big Dog Hotdog might run a cross promotion offering consumers a 12 oz drink and a hotdog for $1.50. The local auto repair service might want to provide its address and hours to attract convenience store buyers to visit its shop. Finally, the local transportation system might want to alert riders to a service disruption in an outlying area. Although FIG. 5 illustrates an example with four message tracks, any number of such message tracks 16 is contemplated and is within the scope of the invention. The number of tracks is limited only by the size of the display, or the repeat time between messages.

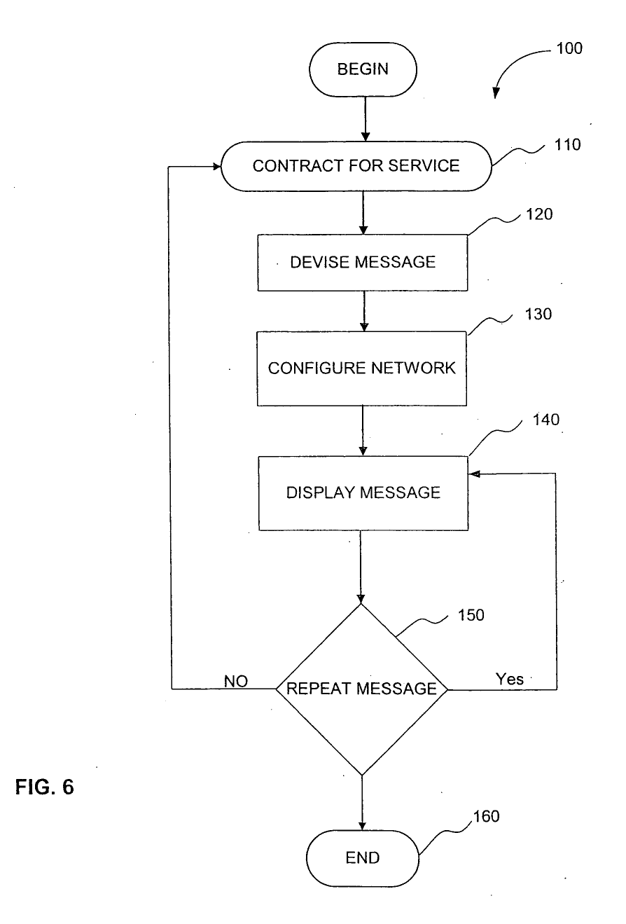

FIG. 6 is an example flow diagram that illustrates the creation and transmission of a message to be displayed on a message track 16 on an EMD 12. A flow 100 begins at process 110 with the strategic partner and the neutral provider contracting for services. The contract identifies the terms of the strategic partnership and contribution of each party. At a process 120 the particulars of the message is devised. The strategic partner may be responsible for determining the content of the message, although the neutral provider could have editorial control to ensure, among other things, that public decency and obscenity standards are maintained. At a process 130 the messaging network 14 is configured to display the message, at which time preselected options can be made available to the strategic partner and neutral provider for input at the data interface 26 in FIG. 2. Table 2 lists possible options that could be considered in formatting the message.

TABLE 2

| Option Type | Option Variables |
|---|---|
| Message type | Scripted, real time, hybrid, emergency, |
| | standard, custom |
| Duration of Message | Number of seconds/minutes of display |
| Frequency of Repetition | Number in hour/day/month/year |
| | Season/sporting event/weekend |
| EMDs selected | All, regional, zip code, area code, store type, |
| | store hours |
| Enhancements | Images, sounds, colors, fonts, typeface, flash |
| | rates |

For example, a given bundle of shared messages 60 could be on a “play list” that changed several times during the day. Because each EMD 12 has two or more message tracks 16, each message could run, for example, five to six seconds, repeating every 20 to 25 seconds.

Returning to FIG. 6, at a process 140 the message is displayed throughout the network on the preselected EMDs 12. It is not necessary for all the EMDs 12 at a given location to run the same bundle of shared messages 60. For example, a local auto repair shop might want to run messages only at EMDs 12 located at gasoline islands 40, but not want to run messages on EMDs 12 located above coolers 38. Likewise, a nationally branded beer seller might want to run a promotion on EMDs 12 at coolers 38, but in the interest of responsible alcohol consumption might not want to run the same promotion at gasoline islands 40. Alternatively, a national retailer might want to run a promotion on all EMDs 12 at all stores in a certain geographic area that are open after 10:00 p.m.; as such not all stores in a given network will be selected to display all the same messages.

Messages can be pre-scripted to run at a predetermined time or can be entered in real time at the data interface 26 (FIG. 2). For example, Ambert Alert bulletins or transportation outages could be entered in real time for immediate transmission. Advertisements are preferably scripted in advance so their content can be approved by the message provider, but advertisements could also be entered in real time. The same message could repeat for a specific time period, for example one week, or each Wednesday or Saturday, or the message could repeat a given number of times, for example 20 times per day. Alternatively, a single message track 16 could be used by a single user alternating messages, or by a series of users sharing a single message track. Message tracks 16 can be sold or leased for a fixed time, for example 5 seconds. Alterantively, longer blocks of time can be sold or leased to be used by a single user wishing to convey a large message or a series of smaller messages by the same or different users that can run together. The messages can be simple words or sounds, or could be words enhanced by graphics and sound. The neutral provider 42 could charge a premium for enhancements, or use enhancements as a bonus for entering into a certain length of contract.

Returning back to FIG. 6, at a decision 150 the system decides whether to repeat the message. This decision will be determined based on the agreement between the message provider and the neutral provider 42, and is configured at the time the message is entered into the system, although messages and message repeat frequency could be modified after entry. If the message is not repeated, the system returns to process 110 to begin the flow with a new message. If the message is repeated, the system returns to process 140 and continues to repeat the message. Some neutral providers 42 may find it advantageous to sell message space in given increments, such as in daily or weekly blocks to reduce the configuration and effort associated with changing the messages and ensuring that message tracks 16 do not go unused. However, it is contemplated that messages may or may not be repeated, and that the frequency of repeat is within the discretion of the neutral provider 42 and message provider.

Although particular embodiments for shared electronic point-of-sale messaging have been discussed, it is not intended that such specific references be considered as limitations upon the scope of this invention, but rather the scope is determined by the following claims and their equivalents.

1. A method of operating shared messaging comprising:
displaying electronic messages from a plurality of users on a single electronic messaging device; and
sharing a cost of providing the electronic messages among the plurality of users.

2. The method of claim 1, wherein displaying electronic messages comprises displaying the electronic messages on a display associated with the electronic messaging device.

3. The method of claim 2, wherein each of the plurality of users displays an electronic message on the display associated with the electronic messaging device.

4. The method of claim 2, wherein each of the plurality of users displays an electronic message on a portion of the display associated with the electronic messaging device.

5. The method of claim 4, wherein each of the plurality of users is assigned a particular portion of the display.

6. The method of claim 1, wherein the electronic messages are advertisements.

7. A method of point-of-sale advertising comprising:
allocating a first portion of an electronic messaging device to a first user;
allocating a second portion of the electronic messaging device to a second user;
delivering a first electronic message to the first portion of the electronic messaging device; and
delivering a second electronic message to the second portion of the electronic messaging device.

8. The method of claim 7, further comprising displaying the first electronic message.

9. The method of claim 7, further comprising displaying the second electronic message.

10. The method of claim 8, wherein the first electronic message is displayed immediately.

11. The method of claim 8, wherein the first electronic message is displayed at a predetermined time.

12. The method of claim 11, wherein the predetermined time is configured by the first user.

13. The method of claim 7, wherein the first electronic message is repeatedly delivered to the first portion.

14. The method of claim 11, wherein the predetermined time is configured by a neutral provider.

15. An electronic messaging device comprising:
a display comprising a plurality of message tracks, each message track configured to communicate a message from a user; and
a data entry device for configuring electronic messages for display.

16. The device of claim 15, further comprising memory associated with the electronic messaging device to store messages for display at a predetermined time.

17. The device of claim 15, wherein each message track is configured to communicate a message from a different user.

18. The device of claim 15, wherein the display is a touch-screen display.

19. The device of claim 15, wherein the data entry device is remote from the electronic messaging device.

20. A shared messaging network comprising:
a neutral provider operating a plurality of displays, each display including a plurality of message tracks, each message track configured to deliver one or more messages, each message contributed by one or more message providers;
a host providing networking capability for networking the plurality of displays into one or more networks;
memory associated with the plurality of displays;
a first message provider contributing content for one or more messages to be delivered to one or more message tracks for publication on one or more displays; and
a second message provider contributing content for one or more messages to be delivered to one or more message tracks for publication on one or more displays.
